(19) United States
(12) Patent Application Publication
(10) Pub. No.: US 2012/0226442 A1
(43) Pub. Date: Sep. 6, 2012

(54) METHOD FOR POSITIONING A WELL RELATIVE TO SEISMIC IMAGE OF THE SUBSOIL

(75) Inventors: Victor Martin, Pau (FR); Severine Lalande, Pau (FR); Christian Cheyron, Pau (FR); Pierre Thore, Pau (FR)

(73) Assignee: TOTAL SA, Courbevoie (FR)

(21) Appl. No.: 13/510,870

(22) PCT Filed: Nov. 20, 2009
(86) PCT No.: PCT/FR2009/052242

§ 371 Date: May 18, 2012

(51) Int. Cl. G06F 19/00

(52) U.S. Cl. 702/6

(57) ABSTRACT

Three seismic waves are emitted from different emission points situated outside the well that is to be positioned relative to a seismic image. The times of arrival of these seismic waves are measured on a detector placed in the well. The propagation of the seismic waves emitted from the respective emission points is simulated using a speed model that has been used to construct the seismic image. The simulation provides the respective wavefronts presented by each of the waves at the end of a time equal to the time of arrival measured on the detector for this wave. The detector can then be positioned in the envelope area of the wavefronts, adjacent to the intersection of the wavefronts estimated in the seismic volume.

### PRIORITY CLAIM

The present application is a National Phase entry of PCT Application No. PCT/FR2009/052242, filed Nov. 20, 2009, the disclosure of which is hereby incorporated by reference herein in its entirety.

### BACKGROUND OF THE INVENTION

The present invention relates to subsoil exploration techniques. It is known, notably in oil exploration, to produce seismic images from series of geophysical measurements performed from the surface and/or in drilling wells. In the seismic reflection technique, these measurements involve the emission into the subsoil of a wave and the measurement of a signal comprising various reflections of the wave on the geological structures encountered. These structures are typically surfaces separating different materials, faults, etc.

The seismic images are two- or three-dimensional representations of the subsoil, the vertical dimension corresponding either to propagation time of the seismic waves or to depth. They are obtained by techniques known as “migration” which use an estimated speed model supplying a map of the propagation speed of the seismic waves in the rocks forming the area being explored. This speed model is used to estimate the positions of the reflectors of the subsoil from seismic surveys. Obviously, the seismic images produced in this way, and the underlying speed models, exhibit certain distortions because they are only estimations derived from a necessarily limited number of measurements.

Other measurements (“logs”) are performed in wells that may have been drilled for this purpose or for other reasons. The information (logs) acquired in this way is reconciled with the observations made on the seismic images. For this, it is necessary to retrieve the trajectory of the well on the seismic image. This operation is here called “tying”.

To perform this seismic to well tying operation, it is conventional to calculate a synthetic trace (or film) from measured variations of a physical parameter along the well. The parameter concerned is typically the speed of sound in the rocky formations passed through by the well, the variations of which are measured by sonic logging. The synthetic trace is then compared to the seismic image and displaced and/or stretched in order to find a position in which the synthetic trace is sufficiently similar to the corresponding trace in the seismic image.

The logs acquired according to depth are often linked to time seismic data by using a time/depth conversion law obtained by picking up, using receivers situated at determined depths in the well, a seismic wave emitted on the surface close to the well (“checkshot”). This law can notably be obtained when determining a vertical seismic profile (VSP). The time/depth conversion law is deduced from the first arrival times, at the receivers, of the wave resulting from the checkshot. Its use to retrieve the position of the well thus relies on the strong hypothesis that the trajectory of the wave from the checkshot is rectilinear. This is true in simple cases with vertical wells and shallow dips, for which the trajectories are almost vertical and rectilinear. On the other hand, in more complex geological cases, and notably in the case of boreholes under salt canopies, the waves emitted on the surface and recorded in the well often do not have a trajectory comparable to that of the surface seismics. The problem is further amplified in the case of deviated boreholes.

The tying can also be done without checkshot. However, the method is then very imprecise when the quality of the image is mediocre or when the speed model used for the migration departs from reality, which is often the case with wells under salt. The result of this is an uncertainty as to the nature of the reflectors thus positioned. Furthermore, if the imaging is highly degraded, e.g. for lack of illumination, the method may simply be impossible to implement, since there is no seismic data to compare with the synthetic trace. In this case, the location uncertainty of the well leads to an uncertainty concerning the extrapolation of the data acquired from the well and concerning the geometry of the reservoirs encountered by the well.

There is therefore a need to refine the techniques for tying wells relative to seismic images.

### SUMMARY OF THE INVENTION

There is proposed a method for positioning a well drilled in the subsoil relative to a seismic image of the subsoil. The method comprises:

emitting at least three seismic waves from different emission points situated outside the well,

measuring the times of arrival of the seismic waves at at least one detector placed in the well;

simulating the propagation of the seismic waves emitted from the respective emission points using a speed model that has been used to construct the seismic image, in order to estimate a respective wavefront presented by each of the waves after a time equal to the time of arrival measured for said wave; and

positioning said detector in an envelope area of the estimated wavefronts in the seismic image.

At least three checkshots are used to position a point of the well incorporating the information from the speed model that has been used to construct the seismic image. The result of this positioning, which corresponds to the location of the detector in the well, is therefore correctly placed relative to the speed model and to the seismic image, whether or not the latter is deformed relative to the real geometry of the subsoil.

The method can be executed for a set of detector positions in the well in order to estimate its trajectory within the seismic image. It thus makes it possible to reliably reconcile the information acquired directly from the well with the observations made on the seismic image. It can also provide an indication of the deformation exhibited by the seismic image, notably if the latter has been depth-migrated, in as much as the real positions of the detectors can be ascertained from the geometry of the borehole.

The method ensures, by construction, consistency between the seismic image and the calculated trajectory of the well and makes it possible to perform calibration in a complex speed environment. Technically, having a calibrated well (i.e. a well that is correctly replaced in the seismic image) in a degraded image, for example under a salt canopy, makes it possible to extend the seismic interpretation into the area of poor visibility with greater confidence. The result of this is a lesser uncertainty concerning the mapping of the reservoir roofs and bases, and therefore a better appreciation of the accumulations of hydrocarbons in place. This type of method can be implemented on pre-stack time migration (PSTM) or pre-stack depth migration (PSDM) seismic data.

The area defined by the envelope of the wavefronts in which a detector will be positioned will usually have a certain extent. To reduce this extent and therefore increase the accuracy of the tying process, it is best to choose the emission points so that the wavefronts have angles between them that are sufficiently large. The accuracy of the positioning of the receiver will also be enhanced if the emission points are suitably chosen in the area of the surface seismic recordings that have contributed to the imaging relating to the geological dip, observed on the detector. The accuracy of the positioning of the receiver can also be enhanced by increasing, beyond three, the number of checkshots from different emission points. A possible method is to use directional detectors, capable of detecting the respective directions of incidence of the seismic waves and of analysing the directions of incidence detected relative to the directions of propagation of the estimated wavefronts.

A particular embodiment of the method further comprises:

performing sonic log measurements in the well;

correcting the sonic log measurements to take into account at least propagation speed differences between the seismic waves and the sound waves used in the sonic log measurements; and

generating a synthetic trace from corrected sonic log measurements for comparison to the seismic image.

The correction of the sonic log measurements may include taking into account information from the speed model along the well, the points of which have been positioned in the seismic image. The sonic log measurements in the well typically include the emission of a sound wave at a first point of the wall of the well and the recording of this sound wave at a second point of the wall of the well spaced apart from the first point along the well. They are advantageously complemented by a time calibration of the recording according to an estimated time of propagation of seismic waves between the first and second points, calculated by integrating the inverse of the propagation speed provided by the speed model along the trajectory of the well positioned in the seismic image.

The envelopes, often called “plumes”, typically appear as parametric surfaces tangential to the estimated wavefronts in the vicinity of their point of intersection. The dip may notably be used for the parametric representation of these surfaces, by varying between −90° and +90° or over a smaller angular range. If there is a need for a pointwise representation of the position of the detector, reference can be made to the point of the envelope where the latter is tangential to the measured dip in the vicinity of the envelope area.

In the ideal case where the speed model employed to construct the seismic image correctly reflects the real parameters, the envelope area of the wavefronts is reduced to the intersection of the wavefronts which, by construction, intersect at the point where the detector is located. The technique proposed here makes it possible to optimize the speed parameters of the model with this remark taken into account. Thus, in one embodiment of the method, a number of positioning operations of at least one detector are carried out using different parameter sets of the speed model to determine different estimated wavefront envelope areas in the seismic image, and a parameter set giving rise to an envelope area of minimum size is selected.

### BRIEF DESCRIPTION OF THE DRAWINGS

Other features and advantages of the present invention will become apparent from the following description of a nonlimiting exemplary embodiment, with reference to the appended drawings, in which:

FIG. 1 schematically represents an exemplary real speed model of the subsoil;

FIG. 2 represents, within the speed model V used to form a seismic image, a seismic wavefront Fᵢ1 originating from a source Sᵢ1;

FIG. 3 represents, within the speed model of FIG. 2, the positioning area of the receiver, which is an envelope of three seismic wavefronts Fᵢ1, Fᵢ2, Fᵢ3 originating from three sources Sᵢ1, Sᵢ2, Sᵢ3; and

FIG. 4 schematically illustrates the construction of the trajectory of a well in the seismic image.

### DESCRIPTION OF EMBODIMENTS

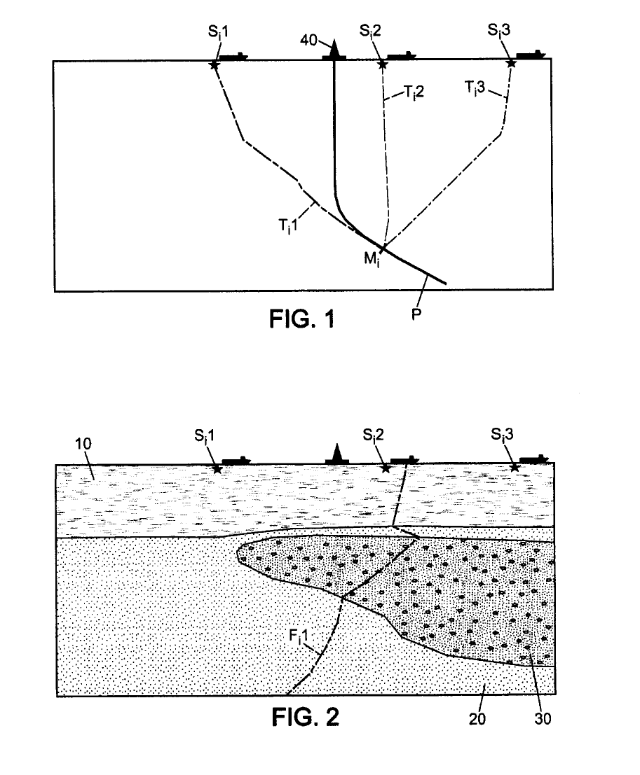

An exemplary embodiment of the method according to the invention is illustrated in FIGS. 1-4 in the case of a well P drilled under the sea. Surface seismic recordings have previously been made, and their processing has made it possible to construct a seismic image, preferably three-dimensional, of an area of the subsoil. The processing may have been performed according to any known migration technique using the estimation of a speed model V, for example a PSDM or PSTM technique.

In the simple case represented in FIG. 1, it is considered that the seismic waves encounter three different environments, namely seawater and two types of rocky formations under the sea bed. The speed model V (FIG. 2) provides a three-dimensional map of the speed of propagation of the seismic waves and therefore, in this simple example, shows three regions where the speed has different values, corresponding to the seawater (10) and to the two types of rocky formations (20, 30). This is a model which does not necessarily accurately represent reality, notably as to the morphology of the regions. It does, however, provide a reference relative to which the seismic image is formed. The speed model V may be quite general and in particular anisotropic.

FIG. 1 also shows the well P that has been drilled from a well head (40) situated on the surface. In this example, it is a deviated well, but it will be understood that the method applies equally to the case of rectilinear wells.

To execute the method according to the invention, one or more seismic wave detectors are lowered into the well P in order to receive waves originating from three or more different emission points, situated outside the well. In the example represented, three different seismic sources Sᵢ1, Sᵢ2, Sᵢ3 are used to position, in the seismic image, the area Mᵢ where the detector has been placed. These sources, for example compressed air-driven, are moored to boats in order to emit the waves into the marine medium in turn. Of course, any type of source can be used, in a manner suited to the measurement environment. Also, it is possible to use only one source moved successively to the desired emission points.

Similarly, any type of seismic wave detector can be used in the well. In order to estimate the trajectory of the well in the seismic image, recordings are made at a number of points M₁, M₂, . . . , Mₙ spaced apart along the well. For this, it is possible to use an array of n detectors, but it will be more commonplace to use one or a small number of detectors arranged in succession at different points Mᵢ along the well. The positions of the sources Sᵢ1, Sᵢ2, Sᵢ3 can be chosen according to the measurement points Mᵢ in the well. They may also be identical (S1, S2, S3) for all the points Mᵢ.

The positions of the points Mᵢ where the detectors are placed are known from the geometry of the well. However, these known positions are not aligned relative to the seismic image and to the underlying speed model given the deformations, which are unknown, that the image and the model may present compared to reality. For different measurements performed in the well to be able to be reconciled with the seismic image, the alignment of the trajectory of the well should be performed in relation to the image.

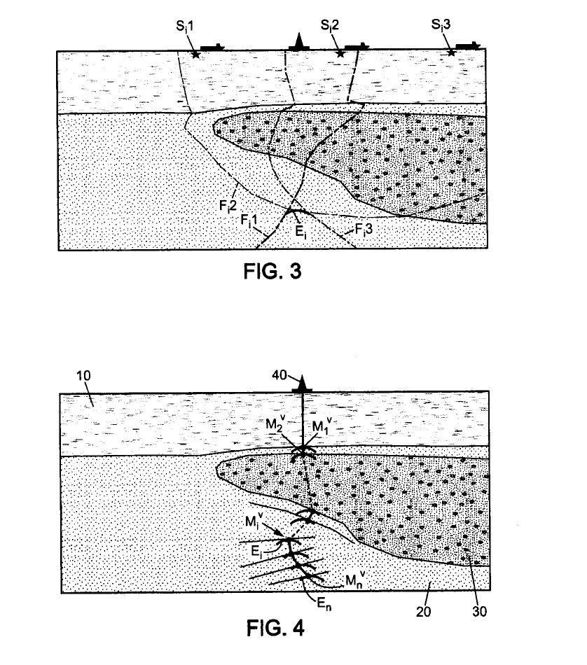

The rays Tᵢ1, Tᵢ2, Tᵢ3 plotted in FIG. 1 correspond to the respective trajectories of the seismic waves between the sources Sᵢ1, Sᵢ2, Sᵢ3 and a measurement point Mᵢ. A simulation calculation is used to estimate the paths of these rays, or the corresponding wavefronts Fᵢ1, Fᵢ2, Fᵢ3 (FIGS. 2 and 3), from information from the speed model V. However, such a simulation provides the estimation of these rays or wavefronts relative to the model V, possibly distorted, and not relative to the real geometry of the subsoil and of the well. The method exploits this by positioning the point Mᵢ using the times of arrival of the seismic waves at the detector.

Hereinafter, the times of first arrival at the detector of the seismic waves from the three sources Sᵢ1, Sᵢ2, Sᵢ3 will also be denoted Tᵢ1, Tᵢ2, Tᵢ3. Each of these arrival times is measured between the instant of emission of the checkshot by the source and the instant of its detection by the detector placed at the point Mᵢ.

For each point Mᵢ of the well, the propagation of the seismic waves emitted is simulated from the three emission points using the speed model V that has been used to construct the seismic image.

The simulation makes it possible to locate in the model V the wavefront Fᵢ1 of the first arrival of the wave from the source Sᵢ1, corresponding to the measured time Tᵢ1. The wavefront obtained Fᵢ1 is a surface schematically represented in FIG. 2.

In depth migration, this wavefront can be obtained conventionally by ray or wavefront tracing or by any other technique well known to those skilled in the art.

In time migration, one way of approximating is to convert the migration model expressed in time into a model expressed in depth by a vertical conversion. Another way, more exact than the vertical conversion, is to perform anisotropic ray tracing directly in the time model according to a technique proposed by B. Reynaud and P. Thore in “Real time migration operators simulated by anisotropic ray tracing”, 55^{th} EAGE Annual Conference, Extended Abstracts, C045, 1993. Yet another method directly uses the exact kinematics of the method and of the migration speed field corresponding to the case to be treated. It consists (1) in positioning Dirac pulses, or other pulses, at the time Tᵢ1 vertical to the recording point in a “stack” or “zero-offset” data block or simply filled with zeros everywhere else, (2) in migrating with the same time or depth migration algorithm and the same speed model, and (3) in pointing the thus created wavefronts.

The same operation is carried out to calculate wavefronts Fᵢ2, Fᵢ3 arriving first from the source Sᵢ2 corresponding to the time Tᵢ2 and from the source Sᵢ3 corresponding to the time Tᵢ3, respectively.

The envelope Eᵢ of the wavefronts then contains a point Mᵢ^{v} which corresponds by construction to the point Mᵢ of the well where the detector was placed (FIG. 3). It constitutes the representation thereof not in an exact spatial coordinate system, but in the speed model V, since it is in the latter that the well positioning calculations are performed.

To estimate the position of the point Mᵢ^{v} within the envelope area, the intersection of the wavefronts is calculated, said intersection defining a volume or a cloud of points of finite extent, rather than a single point. The dimensions of this area depend on the migration methodology error, on the uncertainty concerning the migration speeds, possibly on the failure to take into account the anisotropy of the medium and the position of the checkshot firings. The centre of gravity of the cloud can then be taken as the optimal positioning of the point Mᵢ^{v}. This centre of gravity can be calculated in various ways according to the relative weight that is to be given to the various wavefronts, with, for example, the norms: L1, L2, minmax, etc.

In some configurations, for example when the dip angles measured on the migrated section are close to the tangent to the volume consisting of the intersection cloud, the centre of gravity will preferably be sought at the point of tangency of the local dip with the intersection cloud.

It is desirable for the intersection volume to have an extent that is as small as possible, in order to improve the accuracy of the positioning. Several methods can be used for this purpose, separately or in combination.

A first method involves positioning the sources Sᵢ1, Sᵢ2, Sᵢ3, etc., at emission points situated in the specular area relative to the dips observed in the well. This condition can be sought approximately given a priori knowledge of the real trajectory of the well. This may, possibly, lead to positioning the sources Sᵢ1, Sᵢ2, Sᵢ3 at different points in order to locate different points Mᵢ along the well.

A second method involves positioning the sources Sᵢ1, Sᵢ2, Sᵢ3 at emission points such that the wavefronts Fᵢ1, Fᵢ2, Fᵢ3 have angles between them that are sufficiently large, if possible greater than 60°. Ideally, the wavefronts should mutually intersect at angles of 90°. As indicated previously, this condition can be sought approximately given the a priori knowledge of the real trajectory of the well.

A third method for reducing the extent of the intersection volume involves using more than three seismic wave sources (4, 5, etc.) at different emission points, which reduces the volume of statistical uncertainty concerning the positioning of the points.

A fourth method uses a tool with three components as seismic wave detector in the well. It is thus possible to measure the direction of incidence of the wavefront at the point Mᵢ and to constrain the calculated wavefront to be compatible with the direction measured at the time Tᵢ1, Tᵢ2 or Tᵢ3. Thus, the position of the point Mᵢ^{v} is constrained both by the time and by the direction of arrival of the wavefront.

A fifth method involves appropriately disturbing the migration model of the subsoil so that the focus of the cloud of intersections is optimal. This technique makes it possible at the same time to estimate the quality of the migration model of the PSDM around the well.

Once the various points Mᵢ have been positioned in the model V (Mᵢ^{v}), the trajectory of the well can be obtained as a first approximation by joining the points Mᵢ^{v}, M₂^{v}, . . . , Mₙ^{v} (FIG. 4). A high degree interpolation can also be used to estimate the trajectory of the well in the model V. The trajectory of the well is not necessarily continuous, as shown by E. Robein in “Velocities, Time-imaging and Depth-imaging in Reflection Seismics. Principles and Methods” (EAGE Publications), and as schematically represented by the broken lines in FIG. 4.

The method may be complemented using other measurements taken in the well, and in particular by processing sonic log measurements. The processing conventionally comprises a correction taking into account the propagation speed differences between the seismic waves and sound waves used in the sonic log measurements.

Sonic log measurements are commonly performed in wells. They use a tool having an emitter and a receiver of sound waves applied against the wall of the well and separated by a distance of between one and a few metres. The receiver records the waves emitted by the emitter at a much higher frequency than the seismic waves. In addition to the frequency difference, the geometry of the propagation of these waves between the emitter and the receiver differs substantially from that of the seismic waves used to obtain the surface seismic image. Corrections are applied to the sonic log recordings in order to compensate for these differences.

These corrections comprise a time calibration of the recording as a function of an estimated propagation time of the seismic waves between the emitter and a receiver, which time is reconciled to the time of first arrival of the sound waves as recorded with the sonic log tool. With the method according to the invention, it is advantageous for this estimated time of propagation of the seismic waves to be calculated by integrating the inverse of the propagation speed provided by the model V along the trajectory of the well positioned in the seismic image.

First, after having estimated the trajectory M_{[1-n]}^{v} of the well in the seismic image, the value of the speed is extracted from the model V and then the inverse of this value is integrated along the trajectory M_{[1-n]}^{v} so as to obtain a hypothetical propagation time TM_{[1-n]}^{v} of the seismic waves along the well. The drift of the sonic log can then be corrected by virtue of this law TM_{[1-n]}^{v}.

From the corrected sonic log, a synthetic trace is calculated for comparison with the 3D seismic image. This synthetic trace can be directly applied to the trajectory that has been determined. It can then be used to realign the various measurements performed in the well relative to the seismic image obtained for the surrounding area.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A method of positioning a well drilled in the subsoil relative to a seismic image of the subsoil, comprising:
emitting at least three seismic waves from different emission points situated outside the well,
measuring the times of arrival of said seismic waves at at least one detector placed in the well;
simulating the propagation of said seismic waves emitted from the respective emission points using a speed model that has been used to construct the seismic image, in order to estimate a respective wavefront presented by each of the waves after a time equal to the time of arrival measured for said wave; and
positioning said detector in an envelope area of the estimated wavefronts in the seismic image.

2. The method of claim 1, further comprising:
performing sonic log measurements in the well;
correcting the sonic log measurements to take into account at least propagation speed differences between the seismic waves and sound waves used in the sonic log measurements; and
generating a synthetic trace from corrected sonic log measurements for comparison to the seismic image,
wherein the correction of the sonic log measurements includes taking into account information from said speed model along the well, the points of which have been positioned in the seismic image.

3. The method of claim 1, wherein the sonic log measurements in the well include the emission of a sound wave at a first point of the wall of the well and the recording of said sound wave at a second point of the wall of the well spaced apart from the first point along the well, and a time calibration of the recording according to an estimated time of propagation of seismic waves between said first and second points, calculated by integrating the inverse of the propagation speed provided by the speed model along the trajectory of the well positioned in the seismic image.

4. The method of claim 1, wherein the seismic image is a depth-migrated seismic image.

5. The method of claim 1, wherein the seismic image is a time-migrated seismic image.

6. The method of claim 1, wherein the emission points are chosen so as to enhance the accuracy of the envelope area.

7. The method of claim 6, wherein the emission points are situated in the area of specularity relative to dips observed in the well.

8. The method of claim 6, wherein the emission points are chosen so that the wavefronts have angles between them that are sufficiently large.

9. The method of claim 1, wherein the accuracy of the area of intersection is enhanced by increasing beyond three the number of seismic wave emissions from different emission points.

10. The method of claim 1, wherein said detector is arranged to also detect respective directions of incidence of the seismic waves, and wherein the accuracy of the area of intersection is increased by analysing the directions of incidence detected relative to the directions of propagation of the estimated wavefronts.

11. The method of claim 1, wherein a number of positioning operations of at least one detector are carried out using different parameter sets of the speed model to determine different estimated wavefront enveloping areas in the seismic image, and a parameter set giving rise to an envelope area of minimum size is selected.
